(19) United States
(12) Patent Application Publication
(10) Pub. No.: US 2018/0002882 A1
(43) Pub. Date: Jan. 4, 2018

(54) An Impact Compactor, Compaction System and a Method of Obtaining Soil Strength

(71) Applicant: Roger Arnold Stromsoe, Sandton (ZA)

(72) Inventor: Roger Arnold Stromsoe, Sandton (ZA)

(21) Appl. No.: 15/545,366

(22) PCT Filed: Jan. 21, 2016
(86) PCT No.: PCT/IB2016/050292

§ 371 Date: Jul. 21, 2017

(30) Foreign Application Priority Data
Jan. 21, 2015 (ZA) 2015/00432

(51) Int. Cl. E02D 1/02; E02D 3/026; E01C 21/00; G01N 3/34

(52) U.S. Cl. CPC E02D 1/022; G01N 3/34; E02D 3/026; E01C 21/00; G01N 2203/0019; E02D 2200/1678; E02D 2600/10; G01N 2203/0033; G01N 2203/0037; G01N 2203/0078

(57) ABSTRACT

The invention relates to an impact compactor (10) and to a method and system of obtaining an indication of the soil strength of soil (100) by using an impact compactor (10). The impact compactor (10) includes a chassis 5 structure (12), at least one wheel (14) supportively mounted on the chassis structure (12), and at least one impact drum (16) which is displaceable relative to the chassis structure (12). The method includes travelling with the impact compactor (10) over a soil surface (100) while the drum (16) is in a raised position in which it is spaced from the soil surface (100) and 10 measuring, by using a measuring arrangement (20) which is connected to or forms part of the impact compactor (10), a rut depth (54) of a rut in the soil surface (100) which is formed by the wheel (14) as the impact compactor (10) travels over the soil surface (100).

### BACKGROUND OF THE INVENTION

THIS invention relates to a method of obtaining an indication of soil strength, an impact compactor and a compaction system.

The term “impact compactor” or “impact roller” typically refers to a soil compaction device which includes one/two compactor drums of non-round shape which, when towed/driven over a soil surface, produces a series of periodic impact blows on the soil surface. In this regard, reference is specifically made to PCT patent application no. PCT/IB2014/060350 (Publication No. WO 2014/162261) which is incorporated herein by reference. These periodic blows compact the soil which results in packing and orientating the soil into a more dense and effective particle arrangement, which reduces air voids and prevents further densification and shear failure of the soil.

The compactor drums of the impact compactor each has a series of spaced apart salient points on its periphery with each such salient point followed by a compacting face. As the impact compactor is towed over the soil surface in a first direction (see reference numeral 702 in FIG. 2), for instance by means of a tractor, the compactor drum rises up on each salient/tipping point (see reference numeral 704) and then falls forwardly and downwardly as it passes over that point, with the result that the following compacting face applies an impact blow to the soil surface (The function of the compactor drum is therefore to store potential energy as it rises up on each salient point and then to deliver this energy as an impact blow. The arrows marked by reference numeral 706 in FIG. 2 refer to the penetration depth of the compactor drum into the soil as a result of an impact blow.

In order to achieve the required degree of compaction, a predetermined number of passes is normally applied by the impact compactor to the site. After the predetermined number of passes have been carried out, soil tests are conducted at isolated discrete positions in order to establish whether the required degree of compaction has been achieved. Although these soil tests are only conducted on a very small ratio of the total area undergoing compaction (usually no more than one in one hundred thousandths of the area being compacted) the test results are extrapolated to indicate whether the soil has reached the required degree of compaction; still requires further passes of the impact compactor; or has already exceeded the required degree of compaction. It is therefore often incorrectly assumed that the site has been adequately compacted when in fact portions of the site remain inadequately compacted. Poorly compacted soil can result in costly premature failure of whatever road, railway line, airport runway or other structure the soil may in future be required to carry.

Impact compactors have proved to work well in achieving high levels of soil compaction, even at substantial depths below the soil surface. This allows for the achievement of greatly improved uniformity of soil strength over a site, provided that the entire site is rolled to refusal or near refusal of settlement. However, it is difficult to determine when refusal of settlement has been reached over an entire work site as some areas may reach refusal of settlement earlier than others, resulting in insufficient or superfluous compaction over large areas of the work site. Different soil types may have different elastic properties once refusal of settlement has been achieved and it is therefore important to measure these elastic properties to ensure uniformity of the achieved soil strength.

It can be shown that the amount by which the drum of the impact compactor penetrates into the soil during an impact blow is directly related to the soil strength. Large penetration measurements would correlate to low soil strength and small penetration measurements would correlate to high soil strength. Once the soil refuses further settlement, the penetration measurements achieved will remain constant, indicating that any deformation of the soil achieved is elastic. Elastic deformation occurs when there is a temporary change in the shape of the soil which is fully recovered when the applied stress (the compactor drum) is removed. The response of the soil to unload is immediate. Plastic deformation occurs when there is a permanent change in the shape of the soil which is not recovered when the applied stress is removed. When there is no more plastic deformation during an impact blow, it means that the impact compactor has reached the limit of its compaction capability and cannot improve the soil strength any further. It can be said that the soil reaction force has reached a form of equilibrium with the pressure applied by the falling compactor drums.

Soil density is extensively used by the construction industry to specify, estimate, measure, and control soil compaction even though it is not usually the most relevant engineering property for determining whether the ground is well compacted. This practice was adopted long ago because soil density could be easily determined from measurements using devices such as a nuclear density gauge which is commonly used today.

Current methods for measuring soil strength are relatively slow, labour-intensive and/or lack accuracy. Construction sites are often under sampled, causing inadequate compaction to go undetected or feedback to be provided too late for the cost-effective correction of any problems.

Sometimes an engineer on site implements a so-called ‘proof rolling’ procedure where a heavy construction vehicle, such as a heavily laden truck, drives slowly over the compacted site and the engineer walks next to it and visually inspects the amount the wheels of the vehicle are penetrating into the soil. This can however be quite a time-consuming process and, since it is conducted through visual inspection, is not very accurate.

The Inventor wishes to address at least some of the problems identified above.

### SUMMARY OF THE INVENTION

In accordance with an aspect of the invention there is provided a method of obtaining an indication of the soil strength of soil by using an impact compactor, wherein the impact compactor includes a chassis structure, at least one wheel supportively mounted on the chassis structure, and at least one impact drum which is displaceable relative to the chassis structure, the method including:

travelling with the impact compactor over a soil surface while the drum is in a raised position in which it is spaced from the soil surface; and

measuring, by using a measuring arrangement which is connected to or forms part of the impact compactor, a rut depth of a rut in the soil surface which is formed by the wheel as the impact compactor travels over the soil surface.

The impact compactor may typically include at least one pair of wheels. The method may therefore include measuring a rut depth of a rut in the soil surface which is formed by at least one of the wheels as the impact compactor travels over the soil surface, by using the measuring arrangement.

When an impact compactor travels over the soil surface, with the drum in the raised position, the wheels of the impact compactor typically penetrate into the soil surface, thereby each leaving a rut. Due to elastic deformation which may occur, the depth of the ruts initially formed by the wheels may decrease slightly as the wheels travel onwards (i.e. when the weight of the impact compactor on that particular portion of soil is removed). In other words, as the wheels travel over the soil surface, they each induce a temporary deeper rut (hereinafter referred to as the “temporary rut”) which, as the wheels travel onwards, may change into a slightly shallower, more permanent rut (hereinafter referred to as the “permanent rut”), due to elastic deformation. It is important to bear in mind that for the purposes of this invention, the term “rut depth” refers to both these types of rut depths which are induced by the wheel(s) of the impact compactor.

The method may include measuring the rut depth by determining the distance between a specific position on the impact compactor and a target point on the soil surface, by using the measuring arrangement. The specific position may be on the chassis structure. Alternatively, the specific position may be on another structure which is fixed/secured to the chassis structure. The target point may be located outside the rut. More specifically, the target point may be located in front of the wheel/one of the wheels. Alternatively, the target point may be located between a pair of wheels of the impact compactor (i.e. between ruts formed by the wheels).

The measuring of the rut depth may be conducted on a continuous/continual basis by the measuring arrangement as the impact compactor travels over the soil surface. The method may include determining a geographic position of the impact compactor for a measured rut depth. The method may further include storing the measured rut depth and its corresponding geographic position on a database.

The measuring arrangement may include at least one distance measuring device. The distance measuring device may be a non-contact distance measuring device. The distance measuring device may therefore be mounted on the impact compactor and may be configured to measure the distance to the target point, without needing to make physical contact with the soil surface. The distance measuring device may be a distance measuring sensor. The sensor may be a laser, infrared or ultrasonic distance measuring sensor.

More specifically, the rut depth may be determined by using two or more distance measuring devices which are mounted on the impact compactor.

The method may further include, after measuring the rut depth, correlating the measured rut depth to a scale which indicates soil strength based on a particular rut depth. The correlating may be conducted by using a processor.

In one embodiment, the method may include measuring the rut depth by:
measuring the rut depth of a temporary rut formed by at least one of the wheels by determining the distance between a specific position on the impact compactor and a target point located outside the temporary rut; and
measuring the rut depth of a permanent rut formed by the wheels by at least determining the distance between a specific position on the impact compactor and a target point located behind the wheels and within the permanent rut.

The impact compactor may be a self-propelled impact compactor. Alternatively, the impact compactor may be towable by a tow vehicle (e.g. a tractor).

The method may include temporarily increasing the load applied to the soil surface by the impact compactor through the at least one wheel by adding additional weight temporarily to the impact compactor (i.e. thereby increasing the total weight/mass), and then measuring the rut depth as the impact compactor travels over the soil surface with the additional weight. The additional weight may be added by temporarily attaching/mounting one or more weighted objects to the impact compactor such that the load applied to the soil surface increases as a result of the additional weight. Alternatively, or in addition, the additional weight may be added by introducing material into an inner cavity of the impact drum(s) in order to increase the weight of the impact drum(s), such that the load applied to the soil surface increases as a result of the additional weight. Stated slightly differently, the method may include ballasting the impact drum(s) with material. The material may be a liquid (e.g. water) or any other suitable material.

In accordance with another aspect of the invention there is provided an impact compactor which includes:

a chassis structure;

at least one pair of wheels which is supportively mounted on the chassis structure;

at least one impact drum which is rotatably mounted to the chassis structure by means of a drum mounting arrangement, wherein the drum mounting arrangement is configured to allow displacement of the drum relative to the chassis structure such that the drum can be displaced upwardly and downwardly relative to the chassis structure; and

a measuring arrangement which is operatively connected to the chassis structure or another structure/member which forms part of the impact compactor, and which is configured, when the drum is in a raised position in which it is spaced from the soil surface, to measure a rut depth of a rut formed in a soil surface by at least one of the wheels, as the impact compactor travels over the soil surface.

The said another structure/member may be a structure/member which is connected to the chassis structure.

The measuring arrangement may include a distance measuring device/apparatus which is configured to determine the distance between a specific position on the impact compactor and the soil surface. More specifically, the distance measuring device/apparatus may be configured to determine the distance between the specific position on the impact compactor and a target point on the soil surface. The measuring arrangement may include two or more distance measuring devices/apparatuses.

The distance measuring device may be a distance measuring sensor. The sensor may be mounted on the chassis structure or another structure/member which forms part of the impact compactor. The sensor may be mounted on a structure/member which is connected to the chassis structure. The sensor may be directed towards the soil surface, when in use. It is important to bear in mind that the target point may shift/move along the soil surface as the impact compactor travels there over. The target point is therefore a specific point on the soil surface at a specific point in time, which will shift/move as the impact compactor travels along the soil surface.

The sensor may be a laser, infrared or ultrasonic distance measuring sensor.

The sensor may be directed downwardly at an angle which is substantially perpendicular to a plane in which the chassis structure extends. The chassis structure may typically extend in a horizontal plane, which means that the sensor may be directed operatively, vertically downwardly. Alternatively, the sensor may be directed downwardly at an angle which is acute to the plane in which the chassis structure extends.

The distance measuring device, more specifically the sensor, may be directed such that the target point is located outside a rut(s) formed by the wheels, when in use. The target point of the distance measuring device may be located in front of one of the wheels. Alternatively, the target point may be located between the wheels (or at any point beneath the chassis structure). Stated slightly differently, the pair of wheels define two spaced apart, parallel tracks, and the target point may be located at any position in-between the parallel tracks, when viewed from above.

The distance measuring device/apparatus may include at least a first member and a second member which are connected to, and displaceable relative to, each other, wherein the first member is secured to the chassis structure, or another structure/member which forms part of the impact compactor (e.g. another structure which is connected/secured to the chassis structure), and the second member extends generally downwardly from the first member and contacts the soil surface at a contact point. The distance measuring device/apparatus may be configured such that the second member is displaced relative to the first member when a vertical distance between the first member and the soil surface changes. The distance measuring device/apparatus may include a sensor which is configured to sense the amount of relative displacement between the second and first members. The second member may be pivotally mounted to the first member. As the vertical distance between the first member and the soil surface changes, the second member may pivot relative to the first member.

The sensor of the distance measuring device/apparatus may be an angle measurement sensor which is configured to measure the amount of angular displacement of the second member as it pivots relative to the first member. The angle measurement device may be an inertial angle measurement device. Alternatively, the angle measurement device may be an inclinometer, linear encoder or rotary encoder. The second member may include an elongated part which extends downwardly from the first member and a ground engaging member/formation (e.g. a scraper) mounted to a bottom end of the elongate part and which engages the soil surface. The ground engaging member may be a wheel which is rotatably mounted to a bottom end of the elongate part. The distance measuring device/apparatus may include a biasing means which is configured to urge the second member into engagement with the soil surface, when in use.

The measuring arrangement may include two distance measuring devices. A target point of the one distance measuring device may be located in front of one of the wheels. A target point of the other distance measuring device may be located on the soil surface behind the wheel, within the rut which, in use, is formed by the wheel in the soil surface as it travels there over.

The impact compactor may have a neutral orientation and may include an angle measurement arrangement which is configured to determine the orientation of the impact compactor, when in use, with reference to a neutral orientation. The angle measurement arrangement may be configured to send orientation information to a processor for further processing. A neutral orientation may be when the impact compactor is positioned on a flat, horizontal surface and is driven/pulled horizontally along the flat surface (i.e. parallel to a horizontal plane).

The angle measurement arrangement may include an inertial angle measurement device which includes one or more accelerometers as well as one or more gyroscopes. Alternatively, or in addition, the angle measurement arrangement may include an inclinometer, linear encoder or rotary encoder.

In accordance with another aspect of the invention there is provided a compaction system which includes:
an impact compactor as described above; and
a processor which is communicatively connected to the distance measuring arrangement of the impact compactor in order to allow distance measurement information to be sent from the distance measuring arrangement to the processor.

The processor may be provided on the impact compactor, on-site and/or at a remote site.

The processor may be communicatively connected to the angle measurement arrangement of the impact compactor for receiving angle measurement information therefrom. The processor may be configured, by way of software, to utilise the distance measurement information received from the distance measuring arrangement and angle measurement information received from the angle measurement arrangement, in order to determine the depth of a rut formed in the soil surface by one of the wheels, when in use.

Stated slightly differently, the impact compactor may include an angle measurement arrangement which is configured to determine an orientation of the impact compactor, when in use. The processor may be communicatively connected to the angle measurement arrangement of the impact compactor for receiving orientation information therefrom. The processor may be configured, by way of software, to utilise the distance measurement information received from the distance measuring arrangement and angle measurement information received from the angle measurement arrangement, in order to determine the depth of a rut formed in the soil surface by one of the wheels, when in use.

A geographic location device may be mounted on the impact compactor and may be communicatively connected to the processor. The geographic location device may be a GNSS device/unit.

The processor may be configured, by way of software, to calculate an indication of soil strength by utilising at least the measurement information received from the distance measuring arrangement.

The calculation may be conducted by comparing/correlating the measurement information with a scale which indicates soil strength based on a particular rut depth. The scale may be saved on a database. The database may be accessed by the processor. The processor may therefore be operatively connected to the database.

The impact compactor may be used to determine the amount of pressure the soil can support. A pass/failure criteria dependent on the penetration depth may be determined for the applied pressure. Using correlations to standard soil strength tests, such as a plate load test, penetration depth pass/failure criteria can be calculated by the processor. The processor may therefore be configured to use the criteria in order to determine whether each measured soil penetration depth value passes or fails the required criteria. This information can then be provided to interested parties such as the site engineer in order to see whether any sections of the site require further compaction.

A display screen may be operatively connected to the processor, and the processor may be configured to display information on the calculated indication of soil strength to a user/operator on the display screen.

More specifically, the processor may be configured, by way of software, to calculate an indication of soil strength at a particular geographic position by utilising at least the measurement information received from the distance measurement arrangement and geographic location information received from the geographic location device.

The processor may therefore be configured to display information on the calculated indication of soil strength, with reference to a particular geographic position, to a user/operator on the display screen.

The display screen may form part of a graphical user interface (GUI) to be used by an operator/user. The GUI may be provided on the impact compactor (e.g. inside a cabin of the impact compactor), at a position remote from the impact compactor but on-site (hereinafter referred to as an “on-site” position), or at a remote site. The term “on-site” means at the site at which the soil surface is being compacted by the impact compactor. More specifically, a GUI may be provided: on the impact compactor; on-site and/or at a remote site.

### BRIEF DESCRIPTION OF THE DRAWINGS

The invention will now be described, by way of example, with reference to the accompanying diagrammatic drawings. In the drawings:

FIGS. 1a-c each show an example of a type of impact compactor;

FIG. 2 shows a schematic illustration of how an impact drum of an impact compactor in accordance with the invention rolls and impacts a soils surface during operation;

FIG. 3a shows an end view of an impact compactor in accordance with the invention, when a pair of impact drums thereof is in a raised/inoperative position;

FIG. 3b shows a side view of the impact compactor in FIG. 3a;

FIG. 3c shows a side view of an impact compactor, with one of the impact drums removed;

FIG. 4a shows a bottom view of part of a single axle impact compactor, which indicates various possible mounting positions for a distance measuring sensor;

FIG. 4b shows a bottom view of part of a double axle impact compactor, which indicates various possible mounting positions for a distance measuring sensor;

FIG. 5a shows an end view of an example of an impact compactor in accordance with the invention, where two non-contact distance measuring sensors are used;

FIG. 5b shows a side view of the impact compactor of FIG. 5a;

FIG. 5c shows a schematic illustration of how rut depth is determined by using one of the sensors of the impact compactor of FIG. 5a;

FIG. 5d shows a trigonometric layout of the relative angles and distances applicable when calculating the rut depth by using the other sensor of the impact compactor of FIG. 5a;

FIG. 6a shows an end view of another example of an impact compactor in accordance with the invention, where two non-contact distance measuring sensors are used;

FIG. 6b shows a side view of the impact compactor of FIG. 6a;

FIG. 6c shows a trigonometric layout of the relative angle and distance applicable when calculating the rut depth by using one of the sensors of the impact compactor of FIG. 6a;

FIG. 7 shows a schematic illustration of how a wheel of an impact compactor, in accordance with the invention, penetrates into a soil surface, when travelling there over;

FIG. 8a shows an end view of another example of an impact compactor in accordance with the invention, where two non-contact distance measuring sensors are used;

FIG. 8b shows a side view of the impact compactor of FIG. 8a;

FIG. 8c shows a trigonometric layout of the relative angles and distances applicable when calculating the rut depth by using the sensors of the impact compactor of FIG. 8a, and also illustrates the difference between plastic and elastic deformation;

FIG. 9a shows a side view of a distance measuring contact arrangement of an impact compactor in accordance with the invention;

FIG. 9b shows a side view of a variation of the distance measuring contact arrangement of FIG. 9a;

FIG. 10a shows a side view part of an impact compactor in accordance with the invention, where the distance measuring contact arrangement of FIG. 9a is used, where there is no penetration into a soil surface over which the impact compactor is travelling;

FIG. 10b shows an end view part of the impact compactor of FIG. 10a, where the wheels penetrate into the soil surface;

FIG. 10c shows a side view of the impact compactor of FIG. 10b;

FIG. 10d shows a trigonometric layout of the relative angles and distances applicable when calculating the rut depth of a rut formed as a result of the penetration of the wheels of the impact compactor shown in FIG. 10b;

FIG. 11a shows a side view of part of an impact compactor in accordance with the invention, where the distance measuring contact arrangement of FIG. 9b is used, and where the wheels penetrate into a soil surface over which the impact compactor is travelling;

FIG. 11b shows an end view of the impact compactor of FIG. 11a;

FIG. 11c shows a trigonometric layout of the relative angle and distances applicable when calculating the rut depth of a rut formed as a result of the penetration of the wheels shown in FIG. 11a;

FIG. 12a shows a side view of part of an impact compactor in accordance with the invention, where the distance measuring contact arrangements shown in FIGS. 9a&b are both used and where the wheels penetrate into a soil surface over which the impact compactor is travelling;

FIG. 12b shows an end view of the impact compactor of FIG. 12a;

FIG. 12c shows a trigonometric layout of the relative angles and distances applicable when calculating the rut depth of a rut formed as a result of the penetration of the wheels shown in FIG. 12a;

FIG. 13a shows an end view of an impact compactor in accordance with the invention, which is positioned on a sloping soil surface, thereby resulting in roll.

FIG. 13b shows a side view of the impact compactor of FIG. 13a, which is subjected to a pitch;

FIG. 13c shows a trigonometric layout of the relative angles and distances applicable when calculating the rut depth of a rut formed as a result of the penetration of the wheels shown in FIG. 13b;

FIG. 14 shows side view of an impact compactor in accordance with the invention which includes a scraper;

FIG. 15 illustrates an example of how soil strength can be determined/estimated by using a database of stored test results for different types of soils; and

FIG. 16 shows a simplified, schematic layout of a compaction system in accordance with the invention.

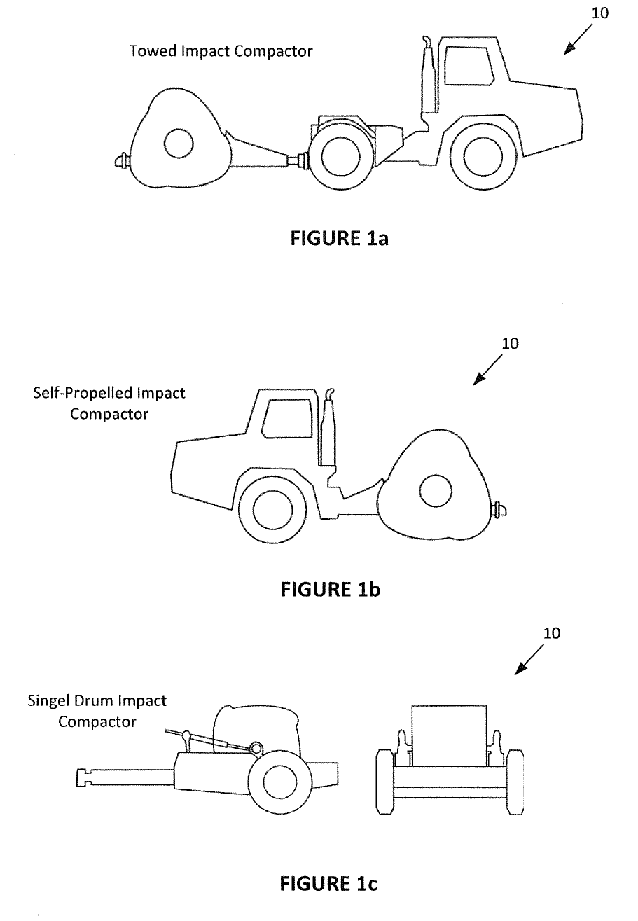

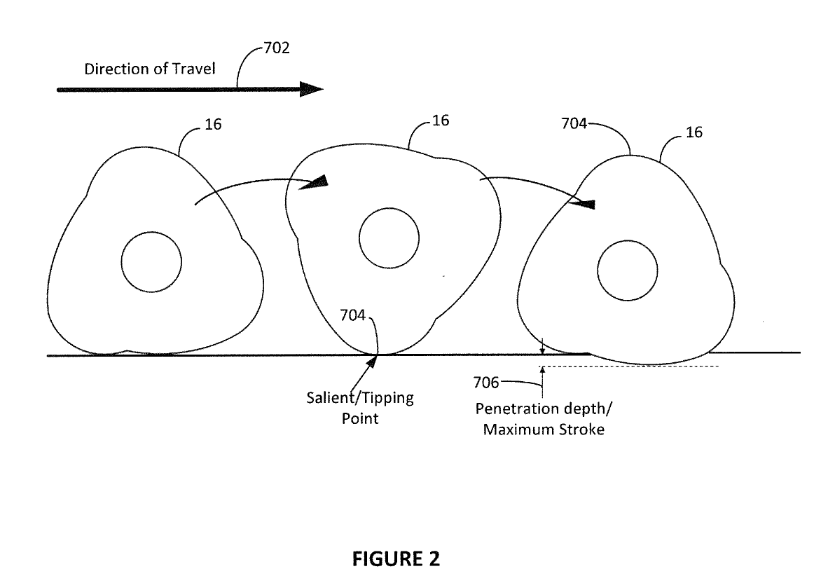

### DESCRIPTION OF PREFERRED EMBODIMENTS

The invention relates to a compaction system which uses an impact compactor to obtain an indication of the soil strength of soil.

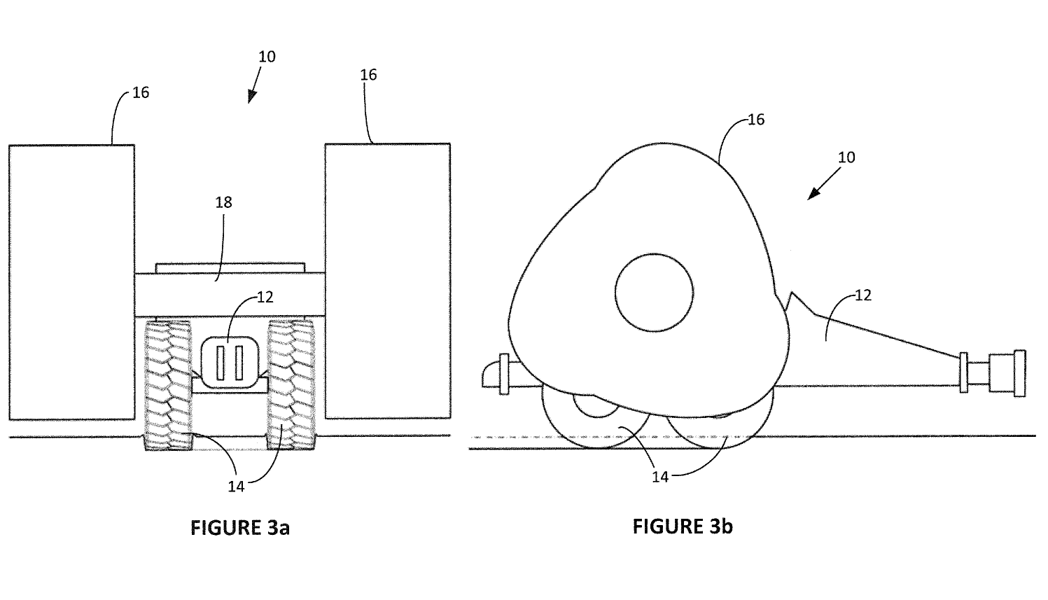

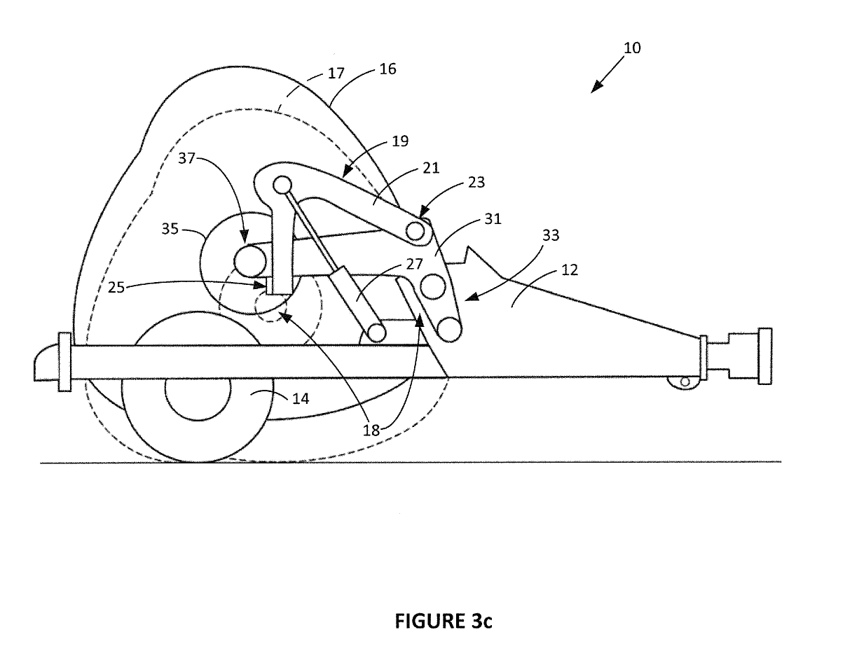

Reference is now specifically made to FIGS. 3a-c. The impact compactor 10 includes a chassis structure 12; one/two pairs of wheels 14 on which the chassis structure 12 is supportively mounted; a drum mounting arrangement 18 on which a pair of non-round impact drums 16 are rotatably mounted, and a lifting arrangement 19 (see specifically FIG. 3c) which is configured to displace the drums 16 upwardly from an operative, lowered condition (see the drum 17 shown in broken lines in FIG. 3c) in which it is positioned on the ground (e.g. on a soil surface) towards a raised position in which the drums are raised off the ground. The drum mounting arrangement 18 includes an L-shaped drag link 31. One end 33 of the drag link 31 is pivotally mounted to the chassis structure 12, and an axle assembly 35 is mounted to an opposite end 37 thereof. The lifting arrangement 19 includes a lifting arm 21 which, at one end, is pivotally mounted to a central portion of the drag link 31, and, at an opposite end, engages the end 37 of the drag link 31. The lifting arrangement 19 further includes a lifting cylinder 27 which is mounted between the chassis structure 12 and the lifting arm 21 in order to lift the drums 16 towards the raised position as shown in FIG. 3a. The operation of the lifting arrangement is well known and will therefore not be described in further detail.

When the impact compactor 10 is in a neutral orientation, the chassis structure 12 extends along a substantially horizontal plane. A neutral orientation is when the impact compactor 10 is positioned on a flat, horizontal surface and is driven/pulled horizontally along the flat surface (i.e. parallel to a horizontal plane).

If the tyres 14 of the impact compactor 10 penetrate into a soil surface 100 when the drums 16 are in their inoperative condition, as a result of the weight, the distance between an underside of the chassis structure 12 and the soil surface 100 beneath the trolley will decrease. The difference in distance from the underside of the chassis structure 12 to the soil surface 100 when there is zero penetration of the tyres 14 into the soil surface (e.g. when standing on concrete) and when there is penetration of the tyres 14 into the soil surface 100, is equal to the depth of penetration of the tyres into the soil surface 100.

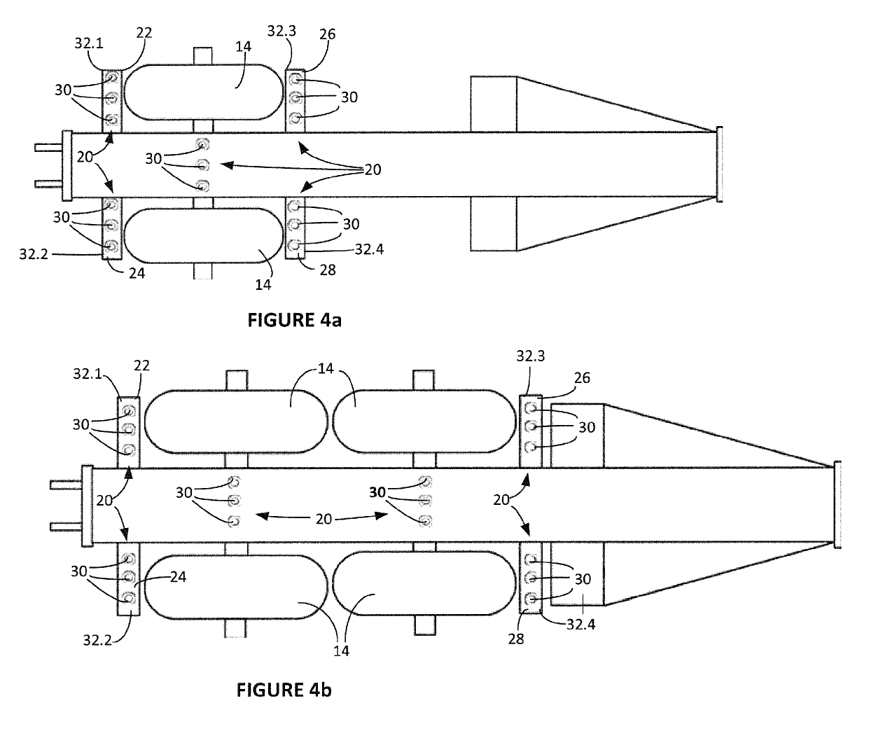

In order to measure the penetration depth, a measurement/measuring arrangement (generally indicated by reference numeral 20) can be used (see FIGS. 4a&b and 5a&b). The measurement arrangement 20 can be mounted either on the chassis structure 12 or another structure 32.1-32.4 which is secured thereto, and extends from, the chassis structure 12 (see specifically FIGS. 4a&b). The structures 32.1-32-4 may, for example, be steel beams.

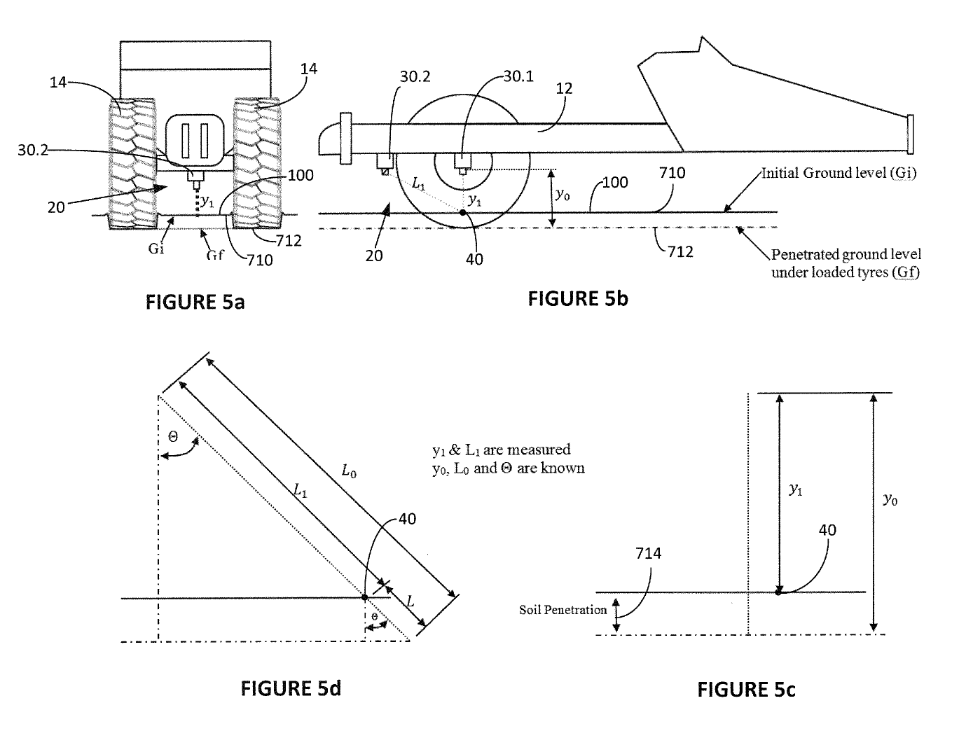

In one example, the measurement arrangement may include one or more distance measuring sensors 30. The sensors 30 may be positioned at various locations on the chassis structure 12 or on one of the other structures 32.1-32.4 and be directed generally downwardly towards the soil surface 100 (see FIGS. 5a&b). The sensors 30 may, for example, be laser, infrared and/or ultrasonic distance measuring sensors or any other non-contact distance measuring sensors.

FIGS. 5a and 5b show an example of two sensors 30.1, 30.2 which are mounted to an underside of the chassis structure 12. The one sensor 30.1 is located between the pair of wheels 14, while the other is located behind the wheels 14, and in-line with the sensor 30.1, when seen in end view (see FIG. 5a). The sensor 30.1 is directed downwardly away from the chassis structure 12, at an angle perpendicular to a plane in which the chassis structure 12 extends, towards a target point 40 on the soil surface 100. Therefore, when the chassis structure 12 is in a neutral orientation, the sensor 30.1 can determine the vertical distance between the underside of the chassis 12 and the soil surface 100. The sensor 30.2 is also directed downwardly away from the chassis structure 12, but extends at an acute angle away from the said plane towards the target point 40.

In FIGS. 5a and 5b, y₀ refers to the vertical distance between the sensor 30.1 and the bottom of the tyre 14, which is a known distance. The vertical distance between the sensor 30.1 and the soil surface is y₁, which is measured by the sensor 30.1. The difference between y₀ and y₁ is equal to the rut depth/penetration depth. In this regard, reference is also made to FIG. 5c (the arrow indicated by reference numeral 714 refers to the penetration depth). Reference numeral 710 refers to the initial ground level, while reference numeral 712 refers to the penetrated ground level (i.e. as a result of the wheels 14).

With regards to sensor 30.2 shown in FIGS. 5a and 5b, the distance L₀ (see FIG. 5d) is known (i.e. it is measured beforehand), whereas L₁ refers to the measured distance to the target point 40. Referring now also to FIG. 5d, the distance L₁ is the distance measured between the sensor 30.2 and the target point 40. The angle θ refers to the known angle between a measurement direction of the sensor 30.2 towards the target point 40 and an axis which extends perpendicular to the plane in which the chassis structure 12 extends. The rut depth/penetration depth can be calculated as follows:

L=L₀−L₁(see FIG. 5d)

Rut depth/penetration depth=L cos(θ)

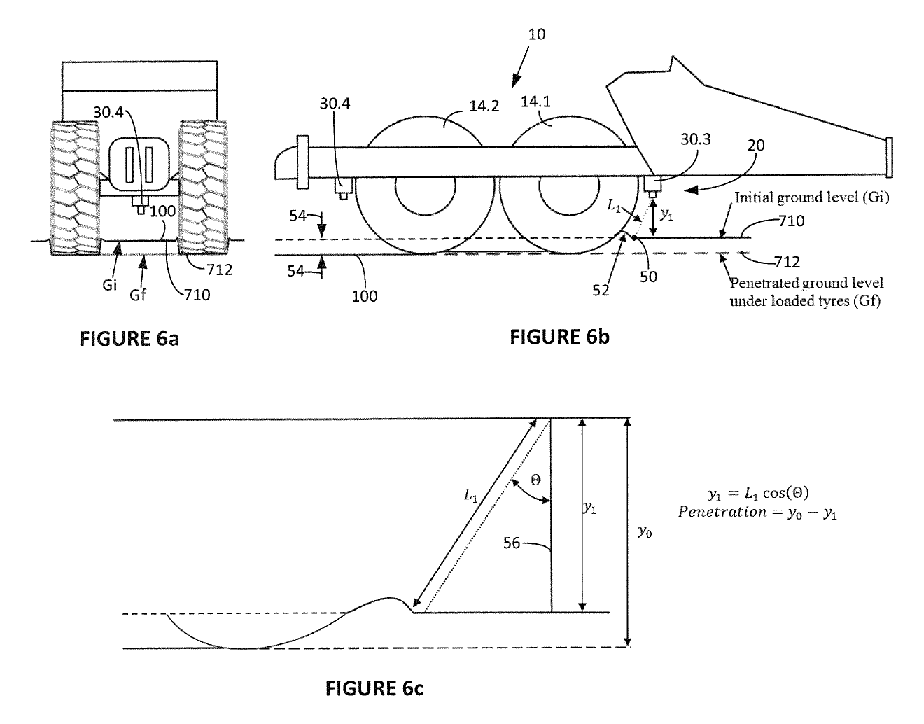

FIGS. 6a-c illustrate another example of using distance measuring sensors 30.3, 30.4, wherein the one sensor 30.3 is located on a structure 28 (see also FIG. 4b) in front of one of the front wheels 14.1 of a double axle impact compactor 10, while the other sensor 30.4 is at a similar position to that of sensor 30.2 shown in FIGS. 5a&b. The sensor 30.3 is directed vertically downwardly (similar to sensor 30.1) in order to measure the distance to the soil surface 100 directly in front of the wheel 14.1.

In FIG. 6c, the vertical distance y₀ between the sensor 30.3 and the bottom part of the wheel 14.1, is a known distance. The vertical distance between the sensor and the soil surface is y₁. The difference between y₀ and y₁ is equal to the soil penetration depth/rut depth (generally indicated by the arrows 54).

In a slightly alternative arrangement, the sensor 30.3 might be angled slightly towards a front part of the wheel 14.1 in order to measure the distance to a target point 50 which is closer to the front of the wheel 14.1.

The target points 50 should however not be too close to the wheel 14.1 in order to help avoid inaccuracies as a result of possible forward upheaval of the soil in front of the wheel 14.1, generally indicated by reference numeral 52. In order to calculate y₀, the distance measured (L₁) and the measurement angle (θ) (relative to a vertical axis 56) are used in the following equation in order to obtain y₁:

y₁=L₁ cos(θ)

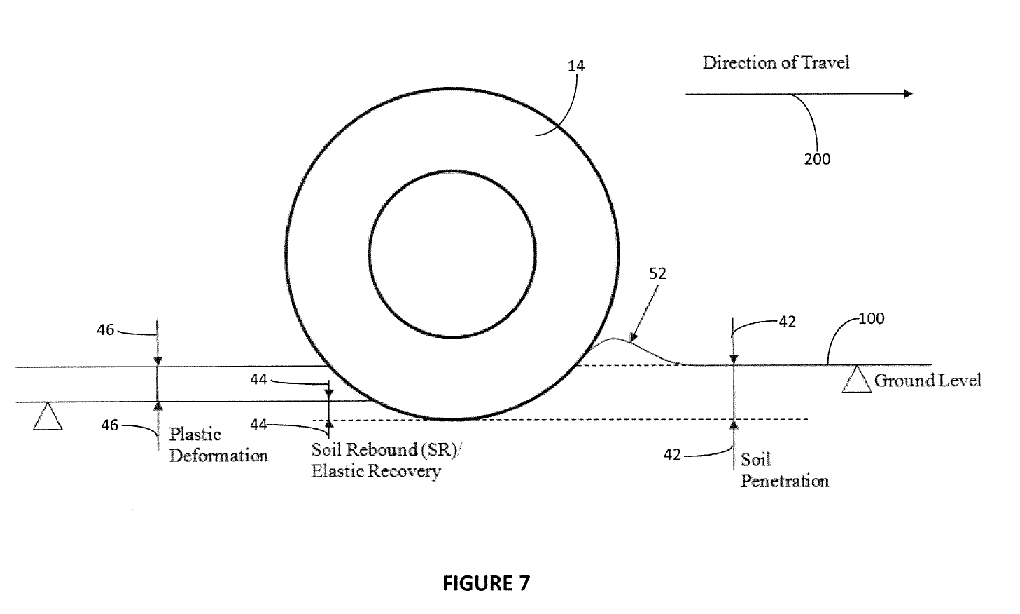

FIG. 7 illustrates how plastic and elastic deformation occur when an impact compactor 10 travels over the soil surface 100. Reference numeral 200 indicates the direction of travel of one of the wheels 14. As the wheel 14 travels over the soil surface 100, it penetrates into the soil surface 100 to form a rut. The depth of the rut, where the wheel is positioned 14, is indicated by the arrows 42. As the wheel 14 travels onwards, the depth of the rut lessens due to elastic deformation (see reference numeral 44), thereby leaving a more permanent rut (which is due to plastic deformation) generally indicated by the arrows 46.

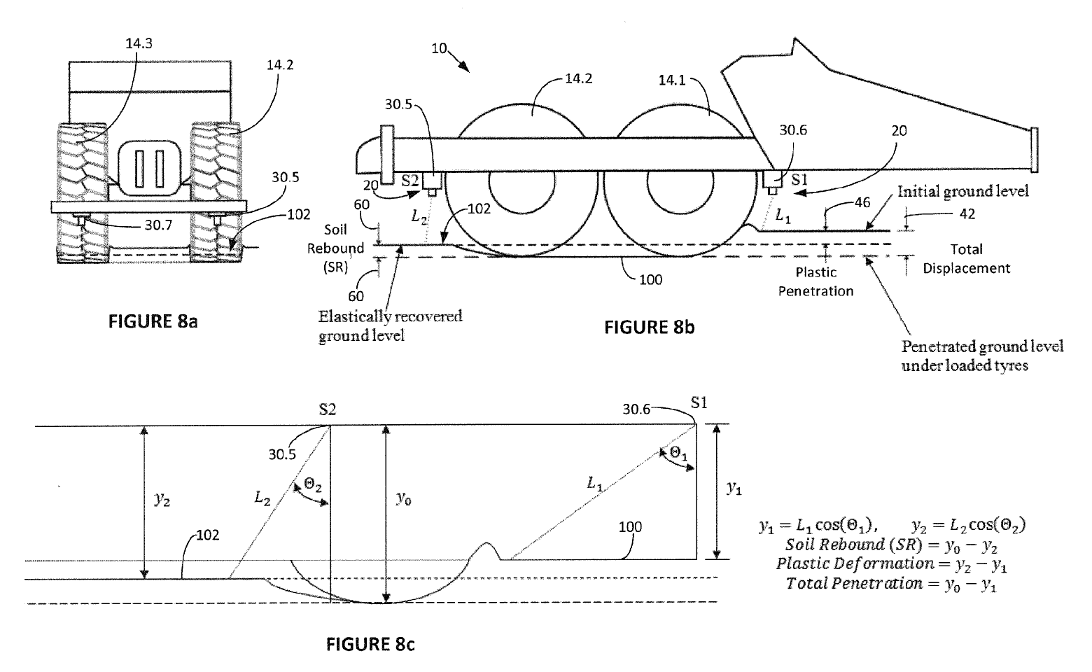

In another example shown in FIGS. 8a-c, a sensor 30.5 is mounted behind the rear wheel 14.1 in order to measure the distance towards the rut 102 formed by the wheels 14.1, 14.2. In FIG. 8c, the vertical distance between the sensor 30.5 and the soil surface 100 is y₂, and the distance measured is L₂. θ₂ is the measurement angle (as described above) of the sensor 30.5. Therefore:

y₂=L₂ cos(θ₂)

Similar to the example shown in FIGS. 6a-c, y₁=L₁ cos(θ₁).

The difference between y₀ and y₂ is the amount of soil rebound/elastic recovery (SR), as a result of elastic deformation of the soil (see the arrows 60). The difference between y₂ and y₁ is equal to the amount of plastic deformation of the soil after the impact compactor 10 has travelled there over. The more permanent rut formed by the wheels 14.1, 14.2 is equal to the amount of plastic deformation (i.e. y₂−y₁). The temporary rut depth caused by the wheels 14.1, 14.2 is equal to the difference between y₀ and y₁. The sensor 30.5 needs to target an area far enough behind the tyres 14.1, 14.2 to ensure that the soil has fully recovered before the reading takes place. An additional sensor could be mounted which can target an area further back from the sensor 30.5, in order to check if the soil recovers any further. Another sensor 30.7 may be mounted behind the wheel 14.3, in a similar fashion to the sensor 30.5 (see FIG. 8a).

The sensors 30 may be mounted in such a way in order to help steady the sensors 30 during operation, as well as to allow for the adjustment of the position (e.g. the measurement angle) of the sensors 30. Rubber mounting pads may, for instance, be used to help damp vibrations. A pivotal mounting arrangement may be used in order to help accommodate for relative movement and positioning adjustment of the sensors 30 (relative to the chassis structure 12).

A servo system may be implemented in order to control the position of the sensor 30 by using data obtained from a dynamic sensor and an electronic control unit. The dynamic sensor takes measurements such as the angle of the sensor with respect to a vertical plane, which could be used to determine the optimum position for the distance measuring sensor in order to obtain more accurate readings. A program of the system can typically send through signals to an electronic control unit of the servo system which controls the positioning of the distance measuring sensor. The electronic control unit uses these signals to instruct the servo system to move the sensor to a new position determined by the program.

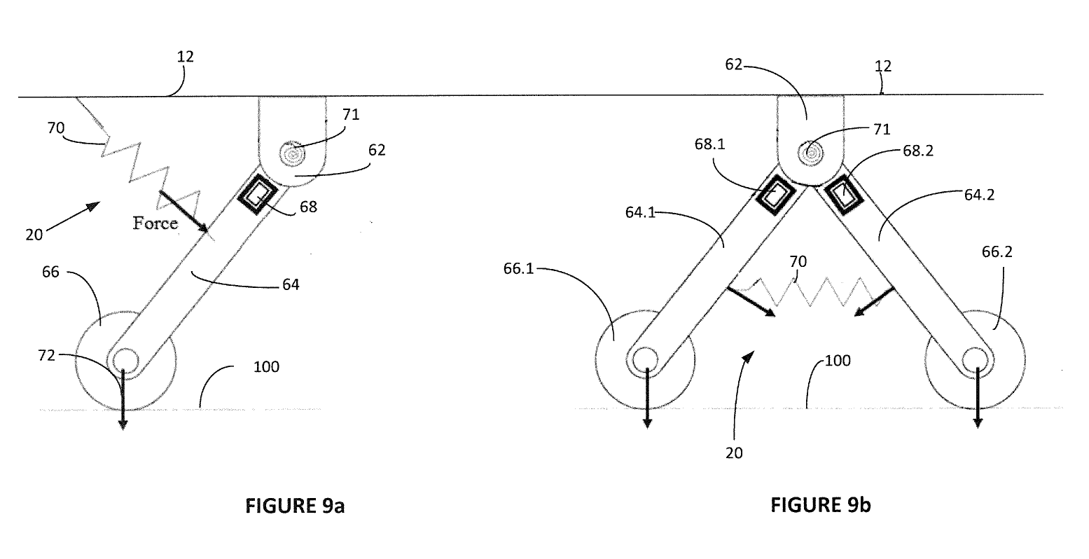

Reference is now specifically made to FIG. 9a. In this example, the measurement arrangement 20 is a distance measuring contact arrangement which makes physical contact with the soil surface 100, in order to help determine the distance from the chassis structure 12 to the soil surface 100. The arrangement 20 has a type of rigid jockey wheel contact mechanism and includes a mounting member 62 (a first member) which is secured to an underside of the chassis structure 12, and an elongate member/rod 64 (a second member) which is pivotally mounted to the mounting member 62 and extends downwardly towards the soil surface 100. A wheel 66 is rotatably mounted to a free end of the rod 64 and engages the soil surface 100.

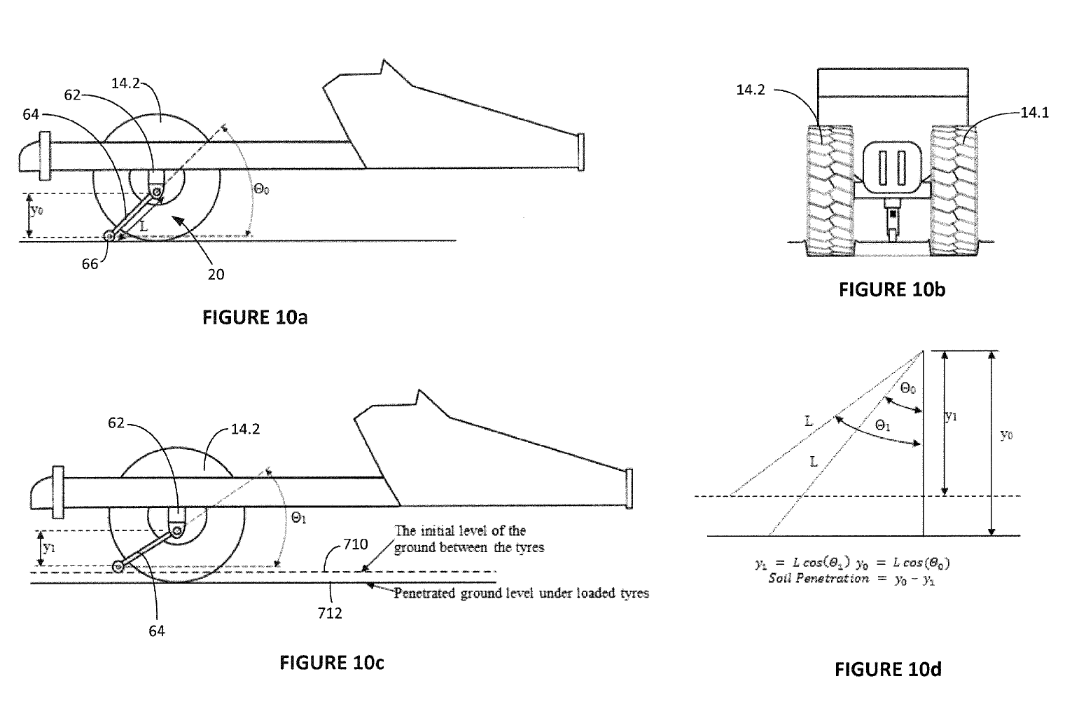

A rotational/angle measurement sensor 68, such as an inertial angle measurement device and/or an inclinometer, is operatively connected to the rod 64 in order to measure the angle of the rod 64. Alternatively, a linear or rotary encoder may be used. The measured angle can then be used in order to calculate the required vertical distance between the mounting member 62 and the soil surface 100. In this regard, reference is specifically made to FIGS. 10a-d. As the wheels 14.1, 14.2 penetrate into the soil surface 100, the angle of the rod 64 changes. By implementing a simple geometric calculation using the length (L) of the rod 64 and the angle measured by the rotational measurement sensor 68, the vertical distance between the mounting member 62 and the soil surface 100 can be calculated.

Reference is now specifically made to FIGS. 10a-d in which the measurement arrangement 20 is mounted between the wheels 14.1, 14.2, y₀=L cos(θ₀), wherein y₀ refers to the vertical distance between the mounting member 62 and the soil surface when there is no penetration into the soil surface 100 (y₀ is therefore known). Similarly, y₁=L cos(θ₁), wherein y₁ refers to the vertical distance between the mounting member 62 and the soil surface 100 when there is penetration into the soil surface 100. The rut depth/penetration depth therefore equals y₀−y₁.

The arrangement 20 includes a biasing means in the form of a linear spring 70, which is mounted between the chassis structure 12 and the rod 64 in order to urge the rod 64 downwardly against the soil surface 100 (see the arrow 72). In addition, or alternatively, a torsion spring 71 may be mounted between the mounting member 62 and rod 64 in order to urge the rod 64 downwardly against the soil surface 100.

In a slightly alternative embodiment, two rods 64.1, 64.2 may be used as shown in FIG. 9b. In this example, reference numerals 68.1 and 68.2 refer to rotational measurement sensors mounted on each rod 64.1, 64.2. A linear spring 70 is mounted between the rods 64.1, 64.2 in order to urge the rods 64.1, 64.2 towards each other, which results in the wheels 66.1, 66.2 urging against the soil surface 100. In addition, or alternatively, a torsion spring 71 may be mounted between the mounting member 62 and the rods 64.1, 64.4 in a similar manner as described above.

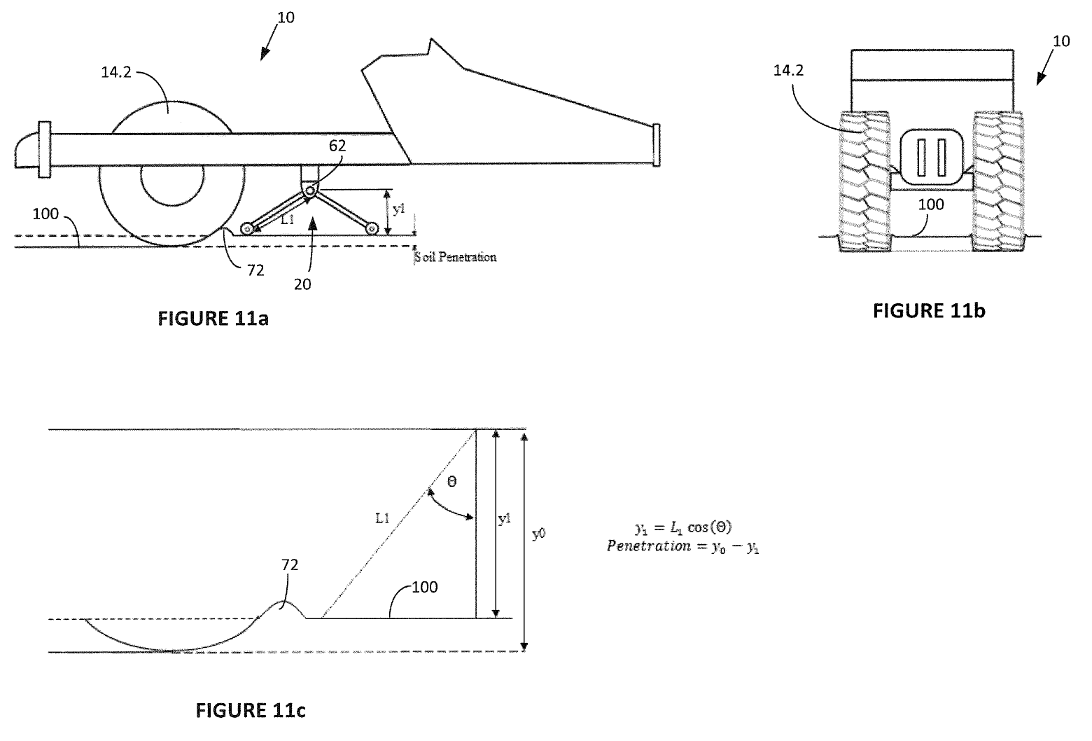

In another example illustrated in FIGS. 11a-c, the arrangement 20 shown in FIG. 9b is mounted on a structure (see structure 26 in FIG. 4b) in front of the wheel 14.2 in order to measure the distance directly in front of the tyre 14.2. The vertical distance between the mounting member 62 and the soil is y₁. y₀ is the same as in the example shown in FIGS. 10a-d. The difference between y₁ and y₀ is equal to the rut depth/soil penetration depth of the tyre 14.2. The arrangement 20 should preferably target an area of the soil surface 100 close to the tyre 14, but not too close in order to avoid inaccuracies due to the forward upheaval of the soil (see reference numeral 72) in front of the tyre 14.2.

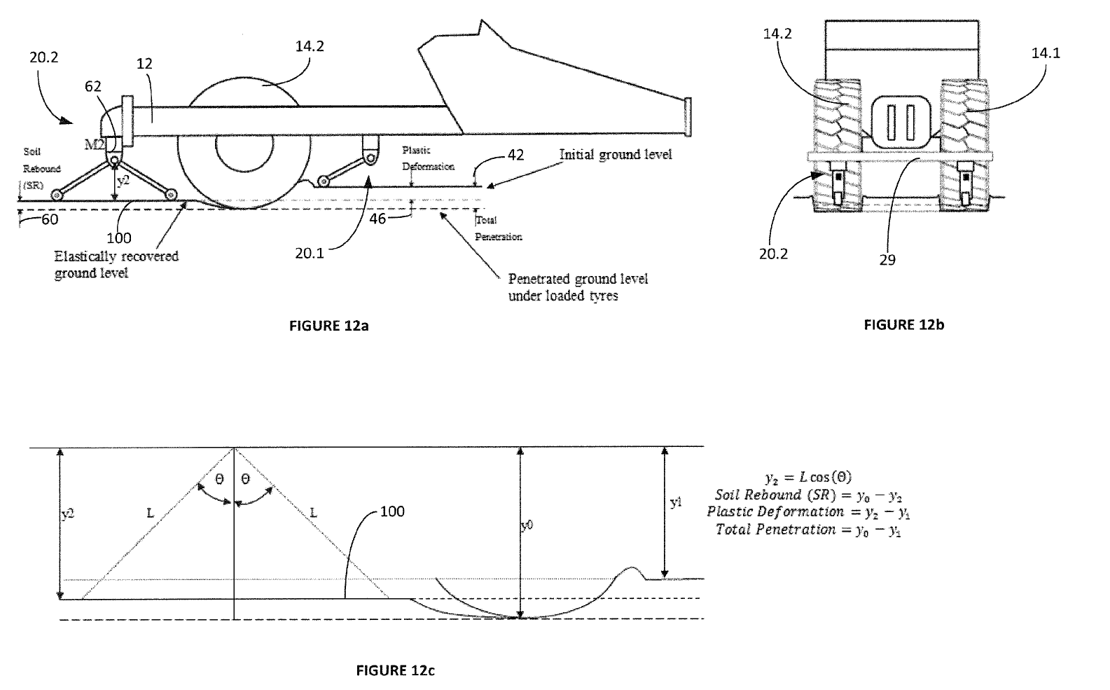

In a further example shown in FIGS. 12a-c, an arrangement 20.1 as shown in FIG. 9a is mounted on a structure (see the structure 26 in FIG. 4b) in front of the wheel 14.2, and an arrangement 20.2, as shown in FIG. 9b, is mounted on a structure 29 (which is secured to the chassis structure 12) behind the wheel 14.2. These arrangements 20.1 and 20.2 are then used to calculate the same distances as the example shown in FIGS. 8a-c. The vertical distance between the mounting member 62 and the soil surface 100 is y₂. y₁ and y₀ are the same as the example shown in FIGS. 11a-c. The difference between y₂ and y₀ is the amount of soil rebound/elastic recovery (SR). The difference between y₁ and y₂ is equal to the amount of plastic deformation of the soil surface 100 left by the wheel 14.2. As show, in FIG. 12c, y₂=L cos(θ).

As mentioned previously, the arrangement 20.2 should preferably be mounted far enough behind the wheel 14.2 in order to target an area of the soil surface 100 which has recovered (preferably fully recovered) before the distance measurement takes place. An additional arrangement 20 could be mounted which can target an area further back from the arrangement 20.2, in order to determine whether the soil surface 100 has recovered any further.

The soil penetration is calculated using distance readings from measurement arrangements 20 illustrated in FIGS. 5a-6c and 8a-12c. Filters and/or other techniques can be implemented to reduce the signal noise of the readings in order to get more accurate readings. Additional sensors can be used to target similar areas in order to check the readings of other sensors or to calculate an average reading from the combination of sensors. The deflection of the tyres of the wheels may not remain constant under all soil conditions. Since the deflection of the tyres might affect the calculated values, this deflection can also be taken into consideration. The tyre type and pressure of the tyre will affect the amount of deflection the tyre will experience. The tyres of an impact compactor 10 are usually pneumatic, pneumatic with tyre fill or solid tyres. The properties of the chosen tyres and the tyre pressure will be generally known. A pressure sensor can also be used to measure the pressure inside the tyres. These values can be inserted into equations that calculate the amount the tyres deflect. The amount of soil penetration can then be calculated taking into consideration the amount of tyre deflection.

In certain cases, it may be useful to increase the load applied by the impact compactor 10 onto the soil surface 100 in order to help obtain more accurate/meaningful soil strength readings. In order to do so, additional weight can be added temporarily to/onto the impact compactor 10. This can be done by attaching or securing weighted object(s) to the impact compactor 10. The term “weighted object(s)” refers to one or more objects which adds/collectively add a significant amount of weight to the impact compactor 10 in order to increase the load onto the soil surface 100 by a significant amount. Alternatively, or in addition, material (e.g. liquid such as water)) can be pumped/introduced into an inner cavity of each of the drums 16 in order to increase the weight of the impact drums 16, such that the load applied to the soil surface 100 increases as a result of the additional weight. Stated slightly differently, the weight of the drums 16 may be increased by effectively ballasting the impact drums 16 with material. Afterwards, the material may again be discharged from the cavities.

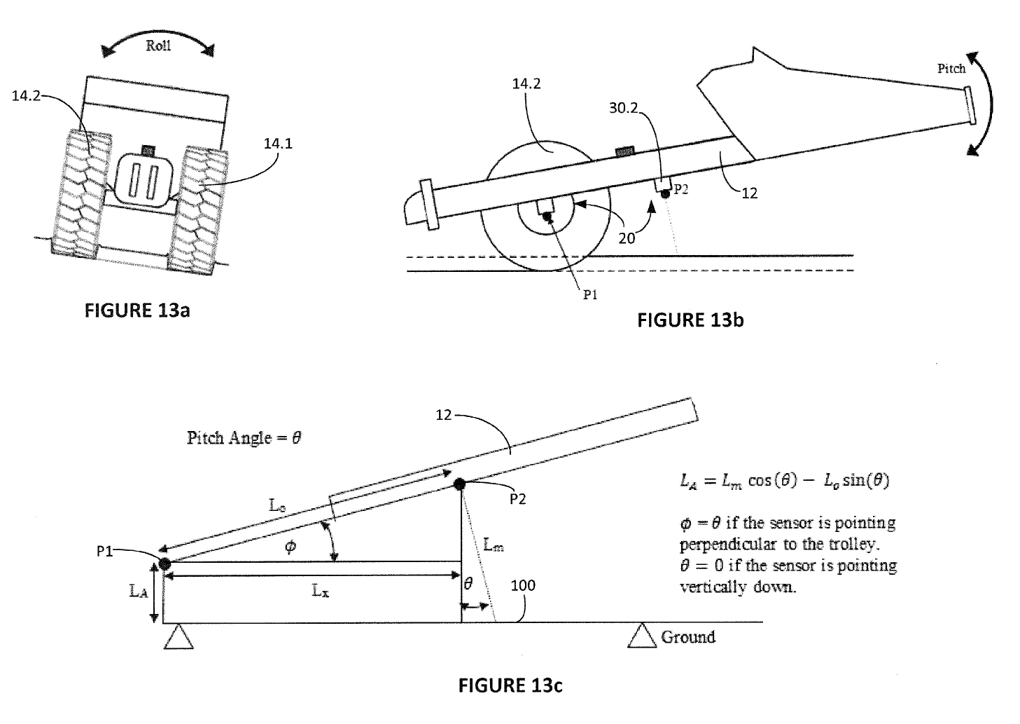

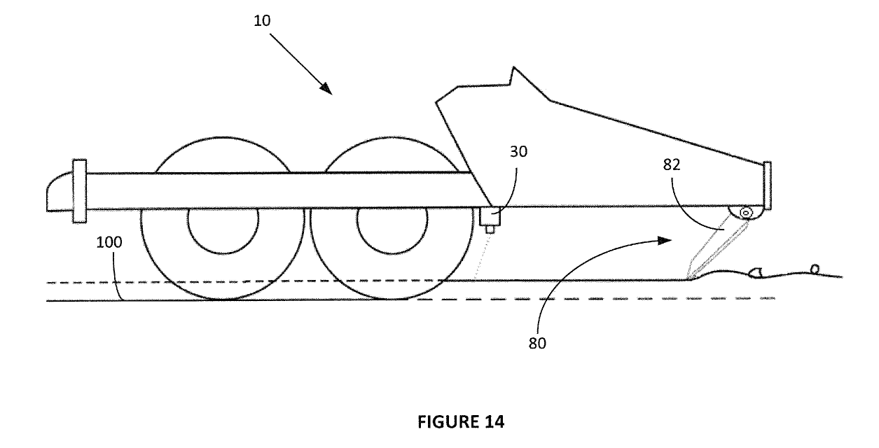

During operation, the impact compactor 10 will not always be 100% level all the time. In order to obtain more accurate readings, the orientation of the impact compactor 10 needs to be taken into account. This includes measuring the pitch and the roll of the impact compactor 10 relative to a level horizontal plane (see FIGS. 13a&b). Sensors, such as inertial angle measurement devices, inclinometers, rotary encoders, linear encoders and other similar devices, can be mounted on the impact compactor 10 in order to measure the changes in the angle/orientation of the impact compactor 10. The angular measurements can be used in combination with the distance measurements in order to calculate more accurate rut depth/soil penetration and plastic deformation values.

For example, if the impact compactor 10 (which in this example includes a trolley that needs to be pulled) is mounted to a tractor such that the impact compactor 10 is not 100% parallel to a horizontal plane (see FIG. 13b), even if it is a relatively small angle, it can make a large difference to the distance measurement, due to the long length of the impact compactor 10. Referring specifically to FIGS. 13b&c, the angle of the impact compactor 10 relative to the horizontal is called the pitch angle (φ). The trolley rotates about an axle (P1) on which the wheels 14.1, 14.2 are mounted. A line (Lₒ) can be drawn from the distance measuring sensor 30.2 (P2) to this point of rotation (P1). The distance measured by the sensor 30.2 is Lₘ. These variables can then be used in an equation in order to calculate what the measured distance would be if the trolley was horizontally level (i.e. the adjusted measured distance L_{A}). The equation and calculations are set out in FIG. 13c. More specifically, φ=8 if the sensor 30.2 (P2) is pointing perpendicular to the chassis structure 12, and θ=0 if the sensor 30.2 (P2) is pointing vertically down. L_{A} can be determined by using the following equation:

L_{A}=Lₘ cos(θ)−Lₒ sin(θ)

The distance measuring sensors 30 can be mounted to the impact compactor 10 in a manner which allows them to move in order to change their targeted area (i.e. the measurement direction). The sensors can be mechanically locked into a certain position and changed manually, if need be, or the movement can be controlled electronically using a servo system. The servo system can use dynamic measurements, such as acceleration and angular velocity, in order to determine the positioning of the distance measuring sensors 30 in order to either stabilize the sensors 30 or adjust their targeted area so as to improve the accuracy of the measurements.

The soil surface 100 may be uneven and/or contain objects, such as rocks, which would affect the penetration measurements significantly. A mechanical device 80 can be installed on the impact compactor 10 which clears the path of unwanted objects and/or makes the soil surface 100 more level in front of the targeted areas of the measurement arrangements 20. Any mechanical device that performs either one or both of these actions could be used.

In one example shown in FIG. 14, a scraper 82 can be pivotally mounted to the impact compactor 10, in front of the targeted areas of the distance measuring sensors 30. The scraper 82 could be biased slightly against or into the soil by using a biasing means which biases the scraper 82 downwardly and urges it against the soil surface 100. The biasing means may, for example, be a torsion spring 84 or a hydraulic cylinder. The scraper 82 will typically help push aside objects, such as rocks, and help to level the soil surface 100.

The pivotal mounting of the scraper 82 helps to prevent damage to the scraper 82 and the rest of the impact compactor 10 since it will generally pivot upwardly when it strikes an object/obstacle too hard to be moved. The biasing means 84 may be configured to allow the blade 82 to pivot upwardly only once the force applied thereto by an object exceeds a certain amount. The biasing means 84 may also be designed so that the force amount can be adjusted in order to accommodate different soil conditions.

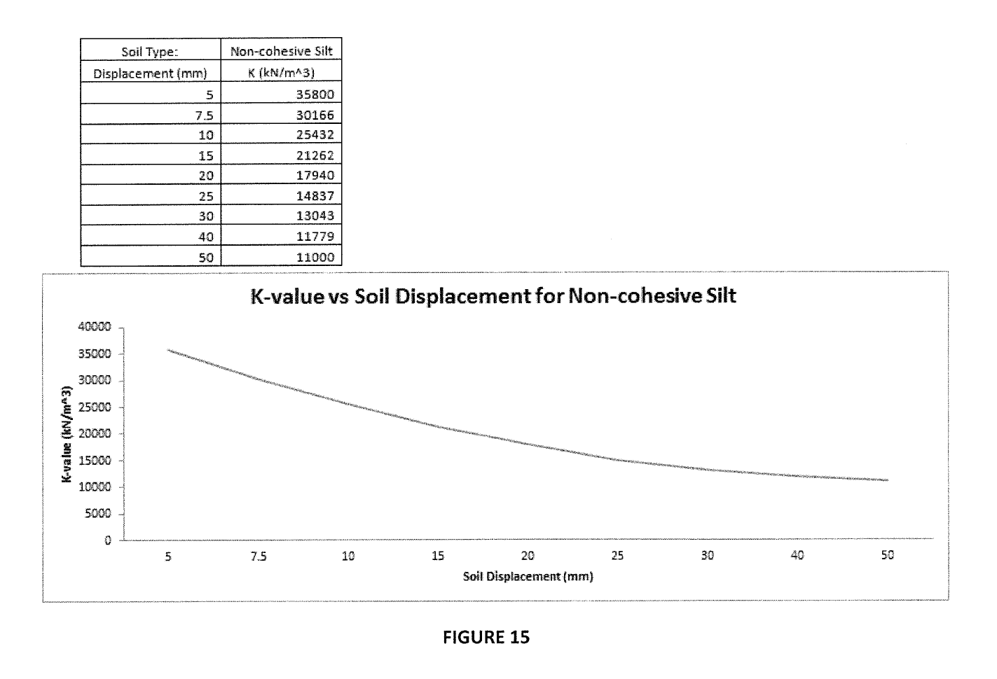

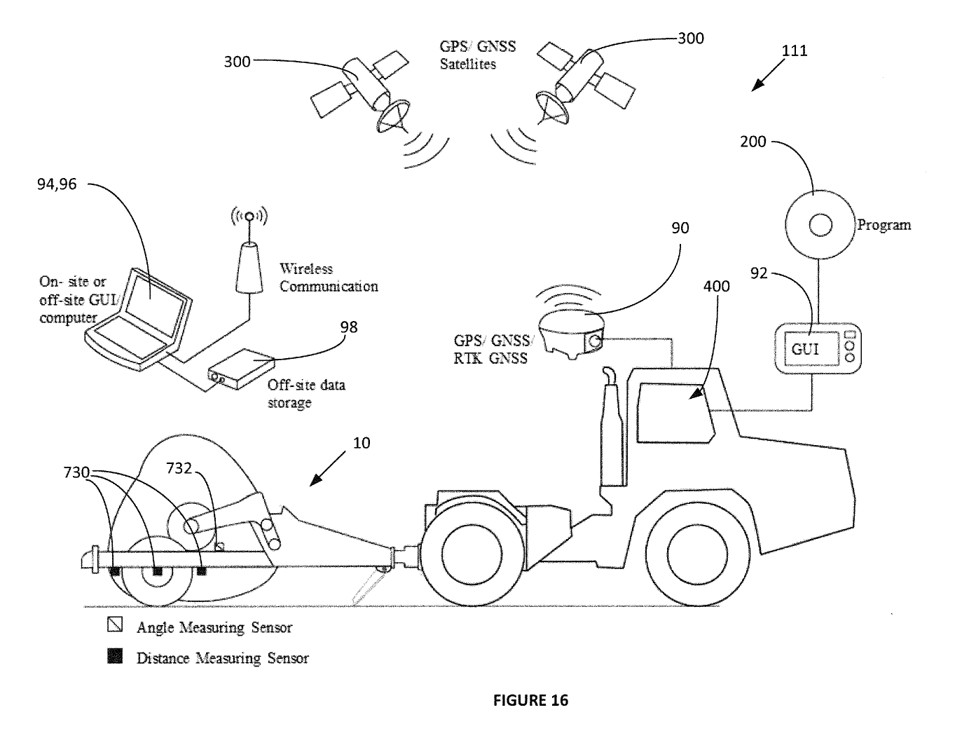

The impact compactor 10 forms part of a compaction system 111 shown in FIG. 16. The data obtained from the rut depth/penetration depth measurements can be used by a processor 200 with appropriate software (e.g. a computer program), in combination with other variables, in equations, to determine/estimate actual soil strength values. More specifically, the processor 200 can use the data to correlate it to soil strength measurements, by using a database which contains information on soil strength values for different soil types and for a range of soil penetration depth values (i.e. rut depth values) that can be used to correlate measured soil penetration/rut depth values with soil strength values from the database (see FIG. 15) In FIG. 16, reference numerals 730 and 732 refer generally to a number of distance measurement sensors and angle measurement sensors (as described above) which can be installed in the impact compactor 10.

A number of different soil strength measurements could be determined by the processor 200 by using:
measured values from the distance measuring sensors 30 (and values from dynamic sensors, such as tyre pressure sensors and inertial angle measurement devices);
assumptions and approximations of certain unknown variables and properties based on experience, lab experiments and/or on site experiments;
formulae that are self-developed and/or found in textbooks, journals or similar sources;
databases of stored information which contains soil strength values for different soil types and for a range of soil penetration values (again see FIG. 15); and
data obtained from performing on-site tests with conventional soil strength measurement methods at locations with known soil penetration values and then extrapolating values for the entire site.

Dynamic sensors such as inertial angle measurement devices, and tyre pressure sensors may be used to get more accurate soil penetration values. The tyre penetration depth is required in calculations and correlations to soil strength. The tyre pressure can be used in determining the contact area of each tyre with the soil surface, where the contact area can be used in calculating the applied pressure.

FIG. 15 shows an example of a database where test results are stored. The actual field test values of displacement (i.e. rut depth) will then use the database in order to correlate the measured rut depth to a K-Value. In this regard, an interpolation can be performed to estimate a K-value for a specific rut depth value.

In one example the impact compactor can be used to determine the soil bearing capacity of the soil surface 100 or the amount of pressure the soil can support. The bearing capacity refers to the amount of pressure the soil can take without shear failure or excessive settlement occurring. The mass of the impact compactor 10 and the number of wheels 14 is known, and the soil penetration depth can be calculated as mentioned above. The tyre pressure and penetration depth can be used in determining the contact area between the tyre and the soil surface. The processor 200 can then calculate the applied pressure by using these values as follows:

$$load per tyre = \frac{mass of impact compactor in kg * 9.81 m \text{/} {s}^{2} ( N )}{number of tyres}$$

$$Applied Pressure = \frac{load per tyre ( N )}{contact area between tyre and soil surface ( {m}^{2} )}$$

A pass/failure criteria dependant on penetration depth measured can be determined for the applied pressure. Using correlations to standard plate load tests, the penetration depth pass/failure criteria can be calculated by the processor 200. The processor 200 can use this criteria in order to determine whether each measured soil penetration depth value passes or fails the required criteria. This information can then be provided to interested parties, such as the site engineer, in order to see whether any sections of the site require further compaction. For example, if it is determined that the soil should have a bearing capacity of 200 kPa, with settlement required to be under 15 mm, as measured by the standard plate load test and the processor 200 determines that the applied pressure between the impact compactor's tyres and the soil surface is 40 kPa, the processor 200 can calculate a pass/failure criteria using this information. The result could be, for example, that all penetration depths measured under 5 mm passes the required criteria and satisfies the required bearing capacity. The processor 200 can show where on the site the required criteria has not been met, and hence which areas on the site require further compaction in order to satisfy the requirements of the soil if measured using standard plate load tests.

In order to improve the validity/accuracy of the soil strength values, the soil moisture content can be taken into account. A device can be included within the system 111 that will perform a spectroscopic measurement of soil moisture content. Any device capable of measuring soil moisture content may be used. The soil moisture content may provide more details on the soil being measured to ensure that certain soil strength measurements are valid and/or accurate.

A global positioning system (GPS), such as GNSS (Global Navigation Satellite System) or RTK GNSS (Real Time Kinetic GNSS) 90, could be used to record the geographic position of the impact compactor 10 accurately (see FIG. 16). The position data can then be used by the processor 200 to provide the soil penetration, soil recovery and/or soil strength values with reference to a specific geographic position. The processor typically forms part of a computer which has a software program that calculates all the relative values with reference to their corresponding geographic positions and then displays this information on a GUI (Graphical User Interface) 92. The GUI 92 could allow the user to choose what is displayed and in what format. The information could be sent to a GUI 94,96 which can be easily viewed on an on-site computer 94 and/or to an off-site computer 96 (or storage device 98) which could then be analysed further.

All the sensors 30 on the impact compactor 10 can typically send through their raw data to a computer, which includes the processor 200, to be analyzed and interpreted by the processor 200 and software. The processor 200, together with the software, can typically do all the necessary calculations, apply the necessary filters to the data and produce the required information. The information can be viewed on the GUI 92. The GPS 90 is configured to send through the coordinates to the computer, in order to provide geographic location coordinates for all the measurements. The data can be used by the processor 200 and software to provide automatic real-time mapping of soil penetration and soil strength values. The software may offer a number of ways to display the information to a user.

Referring specifically to FIG. 16, the GPS 90 can calculate the geographic location coordinates of the impact compactor 10 by using the satellites 300 and then send the coordinates through to the processor 200. The signals from the various sensors are also sent to the processor 200. The GUI could be located in a cabin 400 of the impact compactor 10 and/or somewhere else on site and/or somewhere off site. The data could also be sent to and stored on a storage device 98 off site.

The GUI 92, 94, 96 can include a feature which shows what areas of the work site (i.e. the soil surface 100) require further compaction. For example, this can be done by providing specific colours to different measurements. Measurements that indicate well compacted soil may be allocated a colour such as green or blue, and measurements that indicate poorly compacted soil may be allocated a colour such as red. The compaction site can also be divided into a grid of cells. Each cell would, for example, represent one square metre of land. Each cell would receive a certain colour which depends on all the soil strength and/or penetration measurement data collected/calculated within the cell. The colour of the cell would thus be representative of the soil strength and penetration measurements collected/calculated within the cell. Whilst the system 111 is in the process of determining the soil strength of the work site, the GUI's 92, 94, 96 may typically show the cells and their representative colours on a site map. This will help an operator to know where on the site further compaction is required.

The processor 200 may be configured, by way of software, to plan a prescribed route for the operator to follow, by utilising the measurements, geographic location information and a map, in order to calculate optimal routes to follow and to compact the entire site efficiently and economically. As new measurements and their relative geographic positions are added, the processor 200 can include them in the route calculation and the calculated route can therefore change, if necessary. This may help with compaction optimisation. The operator can follow the prescribed route by using information shown on the GUI 92. Alternatively, the processor can be configured to control the impact compactor 10 automatically. The optimal route plan may help to lower operating costs and reduce the cost of achieving the required degree of compaction on a construction site. The impact compacter 10 used as a soil testing device may help ensure that all areas of the site have been compacted to the required specification.

While various embodiments of the present invention have been described above, it should be understood that they have been presented by way of example only, and not of limitation. The invention is not restricted to the illustrated examples, but the desired features can be implemented by using a variety of alternative architectures and configurations.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention.

Over and above its function as a machine used to compact the soil surface 100, the system 111 gives an impact compactor 10 the additional ability to “proof roll” soil surfaces by providing measurements of the penetration depth formed under the wheels in order to provide an indication of the soil strength and/or level of compaction. The system 111 also gives the impact compactor the ability to measure the amount of elastic deformation of the soil under the wheel load, as well as the amount of plastic deformation of the soil under the wheel load. The system 111 also has the advantage that a single piece of construction equipment that is carrying out compaction on a construction site is also able to carry out soil testing on the same site.

The system 111 can function using either one or more wheel axles on either dual or single drum impact compactors 10. The configuration of the measurement arrangement 20 and system 111 may typically be dependent on the number of wheel axles used. The amount of penetration will depend on how well compacted the soil is. The wheels 14 will penetrate into the soil significantly more at the start of the compaction process when there is less soil strength, compared to the small amount of penetration of the wheels 14 when the ground is well compacted and the soil strength is greater. For this reason, being able to measure the penetration of the wheels 14 into the soil provides a direct measurement of the soil strength achieved.

The impact compactor 10 is unique in that it can perform a dual function of being able to both compact the ground when the compacting drums 16 are used in a compaction mode and to also measure the degree of compaction achieved by raising the drums 16 off the ground and applying the full weight of the drums 16 onto the trolley wheels 14 of the impact compactor 10, thereby transforming the compactor 10 into a soil strength testing device. The invention comprises of mechanisms and sensors that will record data signals required in order to calculate the soil penetration under the load. These measurements can then be correlated to measurements of soil strength such as bearing capacity or other standard methods of measuring soil strength.

1-45. (canceled)

46. A method of obtaining an indication of the soil strength of soil by using an impact compactor, wherein the impact compactor includes a chassis structure, at least one wheel supportively mounted on the chassis structure, and at least one impact drum which is displaceable relative to the chassis structure, the method including:
travelling with the impact compactor over a soil surface while the drum is in a raised position in which it is spaced from the soil surface; and
measuring, by using a measuring arrangement which is connected to or forms part of the impact compactor, a rut depth of a rut in the soil surface which is formed by the wheel as the impact compactor travels over the soil surface.

47. The method of claim 46, which includes measuring the rut depth by determining the distance between a specific position on the impact compactor and a target point on the soil surface, by using the measuring arrangement.

48. The method of claim 47, wherein the specific position is on the chassis structure.

49. The method of claim 47, wherein the specific position is on a structure which is fixed/secured to the chassis structure.

50. The method of claim 47, wherein the target point is located outside the rut.

51. The method of claim 50, wherein the target point is located in front of the wheel.

52. The method of claim 50, wherein the impact compactor includes a pair of wheels and wherein the target point is located between the pair of wheels of the impact compactor.

53. The method of claim 47, wherein the measuring of the rut depth by the measuring arrangement is conducted on a continuous/continual basis as the impact compactor travels over the soil surface.

54. The method of claim 47, which includes determining a geographic position of the impact compactor for a measured rut depth.

55. The method of claim 54, wherein the method further includes storing the measured rut depth and its corresponding geographic position on a database.

56. The method of claim 47, wherein the measuring arrangement may include at least one distance measuring device.

57. The method of claim 56, wherein the distance measuring device is a non-contact distance measuring device which is mounted on the impact compactor and which is configured to measure the distance to the target point, without needing to make physical contact with the soil surface.

58. The method of claim 57, wherein the distance measuring device is a distance measuring sensor.

59. An impact compactor which includes:
a chassis structure;
at least one pair of wheels which is supportively mounted on the chassis structure;
at least one impact drum which is rotatably mounted to the chassis structure by means of a drum mounting arrangement, wherein the drum mounting arrangement is configured to allow displacement of the drum relative to the chassis structure such that the drum can be displaced upwardly and downwardly relative to the chassis structure; and
a measuring arrangement which is operatively connected to the chassis structure or another structure/member which forms part of the impact compactor, and which is configured, when the drum is in a raised position in which it is spaced from the soil surface, to measure a rut depth of a rut formed in a soil surface by at least one of the wheels, as the impact compactor travels over the soil surface.

60. The impact compactor of claim 59, wherein the measuring arrangement includes a distance measuring device/apparatus which is configured to determine the distance between a specific position on the impact compactor and the soil surface.

61. The impact compactor of claim 60, wherein the distance measuring device/apparatus is configured to determine the distance between the specific position on the impact compactor and a target point on the soil surface.

62. The impact compactor of claim 61, wherein the measuring arrangement includes two or more distance measuring devices/apparatuses.

63. The impact compactor of claim 61 wherein the distance measuring device is a distance measuring sensor.

64. The impact compactor of claim 63, wherein the sensor is directed towards the soil surface, when in use.

65. A compaction system which includes:
an impact compactor as claimed in claim 59; and
a processor which is communicatively connected to the distance measuring arrangement of the impact compactor in order to allow distance measurement information to be sent from the distance measuring arrangement to the processor.
